(19) United States
(12) Patent Application Publication
(10) Pub. No.: US 2017/0269265 A1
(43) Pub. Date: Sep. 21, 2017

(54) GRAPHITE SUBSTRATES FOR REFLECTIVE OPTICS

(71) Applicant: Corning Incorporated, Corning, NY (US)

(72) Inventors: Steven George Benson, Walpole, NH (US); Joseph Charles Crifasi, Stoddard, NH (US); Shane Matthew Stephens, Fitzwilliam, NH (US); Leonard Gerard Wamboldt, Sunderland, MA (US); Kenneth Smith Woodard, New Boston, NH (US)

(21) Appl. No.: 15/450,544

(22) Filed: Mar. 6, 2017

Related U.S. Application Data
(60) Provisional application No. 62/310,192, filed on Mar. 18, 2016.

(51) Int. Cl. G02B 1/14; G02B 5/08; G02B 1/04

(52) U.S. Cl. CPC G02B 1/14; G02B 1/04; G02B 5/0808

(57) ABSTRACT

An optical element based on a graphite substrate is provided. The optical element may be a reflective element and may include a finishing layer, adhesion layer, and/or galvanic compatibility layer. Finishing layers include Ni and Si and provide a surface that can be processed to a low finish to support a reflective layer or reflective stack. Graphite substrates are light weight, are amenable to diamond turning and can be machined to near net shape, have low coefficients of thermal expansion to enable operation over wide temperature ranges, and have high chemical stability.

This application claims the benefit of priority under 35 U.S.C. §119 of U.S. Provisional Application Ser. No. 62/310,192 filed on Mar. 18, 2016 the content of which is relied upon and incorporated herein by reference in its entirety.

### FIELD

This description pertains to optical elements. More particularly, this description pertains to reflective optical elements. Most particularly, this description pertains to substrates for reflective optical elements that exhibit corrosion resistance, scratch resistance and have low coefficients of thermal expansion.

### BACKGROUND

Optical systems are widely used for sensing, detection, and light sources. Common applications include remote sensing for homeland security, aerospace and defense, laser systems, solar power concentrators, metrology, and optical scanning systems. Optical systems are needed for operation over a variety of wavelengths, including visible (VIS) through long wave infra-red (LWIR) wavelengths. As the utility and sensitivity of optical systems improves, it is becoming desirable to deploy them in a wider range of operating environments. In particular, there is a need to develop optical systems with high durability that are capable of operating in harsh environments. Harsh environments include corrosive environments (e.g. salt fog, high alkalinity) and humid environments.

Mirrors are central components of optical systems. Mirrors are typically fabricated from a metal or ceramic substrate with a finely polished surface and/or a reflective coating. A preferred material for mirror substrates is an aluminum alloy, T6 6061-Al (T6 6061-Al), due to its relatively low cost, manufacturability, strength and light weight. T6 6061-Al alloy nominally contains 95.8-98.6 wt % Al, 0.04-0.35 wt % Cr, 0.15-0.4 wt % Cu, 0.8-1.2 wt % Mg, 4-0.6.0 wt % Si, and may additionally contain up to 0.75 wt % Fe, 0.155 wt % Mn, 0.155 wt % Ti, 0.255 wt % Zn, and other residual elements (up to 0.05 wt % of any one residual element, with the collective amount of all other residual elements not exceeding 0.155 wt %).

The elements alloyed with Al to form T6 6061-Al alloy provide advantageous properties such as improved strength, scratch resistance, and reduced coefficient of thermal expansion. Analysis of the microstructure of T6 6061-Al alloy, however, reveals the presence of intermetallic particles in the material. The intermetallic particles do not appear in pure Al and are a consequence of the additional elements alloyed with Al to form T6 6061-Al alloy. The presence of intermetallic particles is believed to be responsible for several drawbacks that limit the application of T6 6061-Al alloy. First, the intermetallic particles contribute to roughness on the surface and lead to a decrease in reflected intensity and optical throughput due to scattering losses. Second, the intermetallic particles differ in hardness from the surrounding material. The contrast in hardness leads to local differences in polishability on the surface of the material and make it difficult to achieve a fine finish. Third, the intermetallic particles, or the grain boundaries associated with them, constitute sites of high reactivity that make T6 6061-Al alloy susceptible to corrosion.

There accordingly remains a need to develop substrates for mirrors that are capable of deployment in corrosive chemical environments, that exhibit low thermal expansion to ensure stable operation over wide temperature ranges, and that can be processed to achieve low surface finish.

### SUMMARY

An optical element based on a graphite substrate is provided. The optical element may be a reflective element and may include a finishing layer, adhesion layer, and/or galvanic-compatibility layer. Finishing layers include Ni and Si and provide a surface that can be processed to a low finish to support a reflective layer or reflective stack. Graphite substrates are light weight, are amenable to diamond turning and can be machined to near net shape, have low coefficients of thermal expansion to enable operation over wide temperature ranges, and have high chemical stability.

The present disclosure extends to:

An optical element comprising:

a graphite substrate; and

a finishing layer in direct or indirect contact with said graphite substrate, said finishing layer having an rms surface roughness less than 50Å.

The present disclosure extends to:

An optical element comprising:

a graphite substrate, said graphite substrate having a diamond-turned surface.

The present disclosure extends to:

A method for forming an optical element comprising:

diamond turning a surface of a graphite substrate.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present description, and together with the specification serve to explain principles and operation of methods, products, and compositions embraced by the present description. Features shown in the drawing are illustrative of selected embodiments of the present description and are not necessarily depicted in proper scale.

### BRIEF DESCRIPTION OF THE DRAWINGS

While the specification concludes with claims particularly pointing out and distinctly claiming the subject matter of the written description, it is believed that the specification will be better understood from the following written description when taken in conjunction with the accompanying drawings, wherein:

FIG. 1 shows images obtained from an optical surface profiler of the surface of a graphite sample having a grain size of 10.0 μm and a density of 1.77 g/cm³.

FIG. 2 shows images obtained from an optical surface profiler of the surface of a graphite sample having a grain size of 2.0 μm and a density of 2.68 g/cm³.

FIG. 3 shows images obtained from an optical surface profiler of the surface of a graphite sample having a grain size of 2.0 μm and a density of 1.84 g/cm³.

FIG. 4 shows images of a Ni-plated graphite substrate before and after finishing.

FIG. 5 shows images of the surface of a Ni finishing layer on a graphite substrate after diamond turning (upper) and polishing after diamond turning (lower).

FIG. 6 shows SEM images of the surface of a graphite substrate (grain size=10 μm) before (upper) and after (lower) deposition of a Si coating.

FIG. 7 shows images obtained from an optical surface profiler of the surface of a Si finishing layer on a graphite substrate (grain size=10 μm).

FIG. 8 shows a reflecting optic that includes a Si finishing layer on a graphite substrate (grain size=10 μm).

FIG. 9 shows images of the surface of a graphite substrate (grain size=2 μm) before (upper) and after (lower) deposition of a Si coating.

FIG. 10 shows images obtained from an optical surface profiler of the surface of a Si finishing layer on a graphite substrate (grain size=2 μm).

FIG. 11 shows the reflectance of an Au reflective coating in three optical elements.

FIG. 12 shows the reflectance of an Ag reflective coating in an optical element having a graphite substrate.

FIG. 13 shows an optical element on a graphite substrate that includes a galvanic-compatibility layer along with a graph showing the reflectance of the optical element.

The embodiments set forth in the drawings are illustrative in nature and not intended to be limiting of the scope of the detailed description or claims. Whenever possible, the same reference numeral will be used throughout the drawings to refer to the same or like feature.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purpose of describing particular aspects only and is not intended to be limiting.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. Thus, if a class of sub stituents A, B, and/or C are disclosed as well as a class of substituents D, E, and/or F, and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and/or C; D, E, and/or F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and/or C; D, E, and/or F; and the example combination A-D. This concept applies to all aspects of this disclosure including, but not limited to any components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

In this specification and in the claims which follow, reference will be made to a number of terms which shall be defined to have the following meanings:

The term “about” references all terms in the range unless otherwise stated. For example, about 1, 2, or 3 is equivalent to about 1, about 2, or about 3, and further comprises from about 1-3, from about 1-2, and from about 2-3. Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

As used herein, contact refers to direct contact or indirect contact. Elements in direct contact touch each other. Elements in indirect contact do not touch each other, but are otherwise joined to each other. Elements in contact may be rigidly or non-rigidly joined. Contacting refers to placing two elements in direct or indirect contact. Elements in direct (indirect) contact may be said to directly (indirectly) contact each other.

Ordering of layers in a sequence of layers in the present optical elements will be described relative to the substrate. The substrate forms the base of the optical element.

As used herein, the term “on” refers to direct or indirect contact. If one layer is referred to herein as being on another layer, the two layers are in direct or indirect contact.

Unless otherwise specified herein, the terms “finish” or “surface finish” refer to the root-mean-square (rms) roughness of a surface. A surface with low roughness may be said to have a low finish and a surface with high roughness may be said to have a high finish. Optical surfaces with low finish are smoother and are preferable for the optical elements described herein.

Reference will now be made in detail to illustrative embodiments of the present description.

The present description provides a substrate for reflective optical elements that features low thermal expansion, machinability to fine finish, chemical inertness and stability in harsh environments, and light weight. The present description also provides reflective optical elements utilizing the substrate. The reflective optical element includes a reflective layer or a reflective stack on the surface of the substrate. A reflective stack is a combination of two or more layers that cooperate to provide reflection or other optical effect.

The optical element may also include a finishing layer on the surface of the substrate. The finishing layer has a surface that can be processed to a fine finish. The reflective layer or reflective stack may be formed directly on the finishing layer. If the finishing layer is absent, the reflective layer or reflective stack may be formed directly on the substrate.

The optical element may also include a galvanic-compatibility layer between a finishing layer, a reflective layer or reflective stack and the substrate. The galvanic-compatibility layer aids in corrosion resistance by insuring that the finishing layer, reflective layer or reflective stack has an anodic index sufficiently similar to that of an underlying layer or substrate to promote resistance to corrosion. The galvanic-compatibility layer may also function as a finishing layer.

The optical element may also include an adhesion layer to promote adhesion between a finishing layer, a reflective layer or reflective stack and an underlying layer or substrate. An adhesion layer may be positioned between one or more of a finishing layer, a galvanic-compatibility layer, a reflective layer or reflective stack and an underlying layer or substrate. The adhesion layer may also function as a finishing layer or galvanic-compatibility layer.

The present description also provides methods for finishing the substrate and methods for forming a finishing layer, an adhesion layer, a galvanic-compatibility layer, a reflective layer, and/or a reflective stack on the substrate.

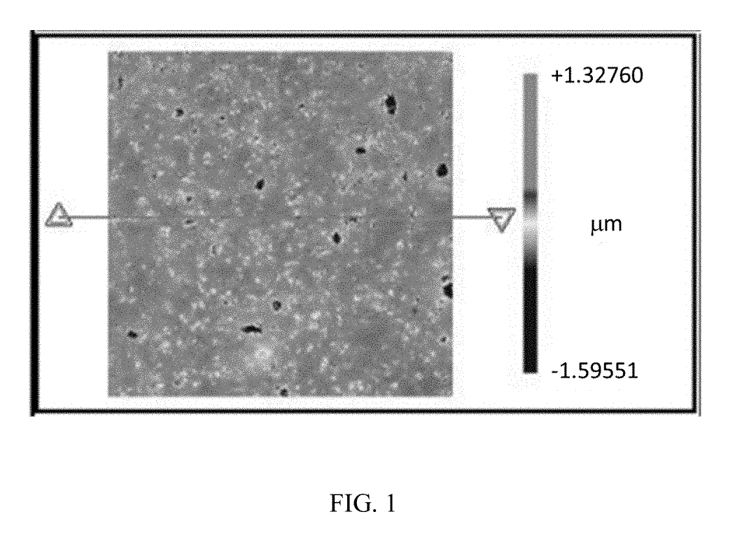

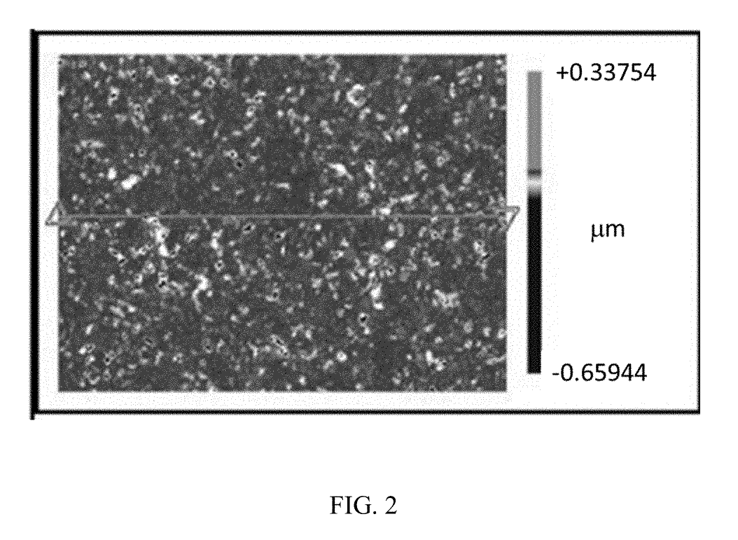

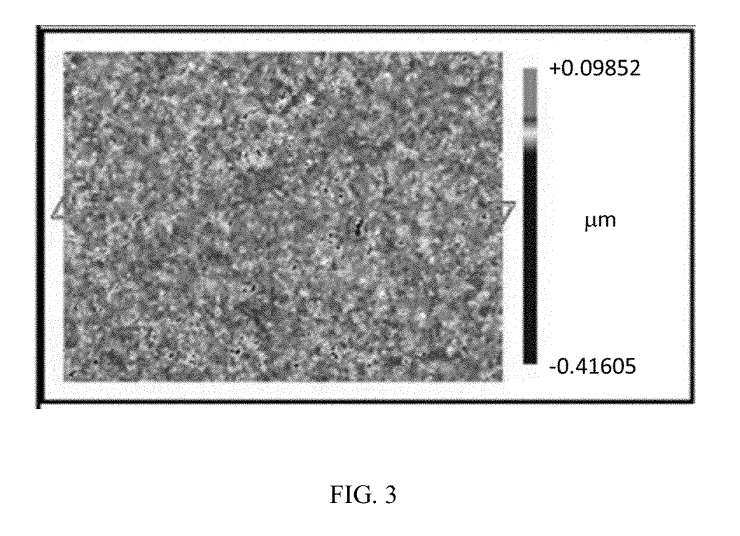

The substrate includes graphite. Graphite is a desirable material for a substrate because it has low density, low thermal expansion, high chemical stability, and can be machined to near net shape. Graphite can be fabricated in various forms that differ in grain size and density. To understand the effect of grain size and density of graphite on surface finish, three samples of graphite were tested. Graphite Sample 1 had a density of 1.77 g/cm³ and an average grain size of 10 μm. Graphite Sample 2 had a density of 2.68 g/cm³ and an average grain size of 3 μm. Graphite Sample 3 had a density of 1.84 g/cm³ and an average grain size of 2 μm. Graphite Sample 1 was obtained from Poco Graphite, Inc. (an Entegris Company (Billerica, Mass.), product no. PLS-2). Graphite Samples 2 and 3 were obtained from MWI, Inc. (Rochester, N.Y.; product nos. HK-6C and EC-17). The finish of the treated graphite samples was assessed with an optical surface profiler (Zygo New View 600 and 7300, with 20X objective set at 1X magnification). Images of the surfaces of graphite Samples 1-3 were obtained with the profiler and are shown, respectively, in FIGS. 1-3. Surface finish was characterized by determining root-mean-square roughness over ten separate 0.5 mm×0.5 mm regions of each graphite sample and averaging the results. Peak-to-valley (PV) roughness was also obtained for each of the ten measurement regions and averaged to provide a result for each graphite sample. Peak-to-valley roughness measures the difference between the highest and lowest positions of the surface within a measurement area. The results are summarized in Table 1.

TABLE 1
Root-Mean-Square and Peak-to-Valley Roughness of Graphite Samples

| | Grain Size | Density | RMS Roughness | PV Roughness |
|---|---|---|---|---|
| Sample | (μm) | (g/cm³) | (Å) | (Å) |
| 1 | 10.0 | 1.77 | 1010 | 28400 |
| 2 | 3.0 | 2.68 | 162 | 9970 |
| 3 | 2.0 | 1.84 | 99 | 5146 |

The SEM results indicate that lower surface finish is obtained for graphite samples having small grain size and/or higher density. Graphite substrates of the present optical elements may have a grain size less than 10.0 μm, or less than 7.0 μm, or less than 5.0 μm, or less than 3.0 μm, or in the range from 0.5 μm to 7.0 μm, or in the range from 0.5 μm to 5.0 μm, or in the range from 0.5 μm to 3.0 μm, or in the range from 1.0 μm to 5.0 μm, or in the range from 1.0 μm to 3.0 μm, or in the range from 1.5 μm to 5.0 μm, or in the range from 1.5 μm to 3.0 μm.

Low finish of the graphite substrate may be obtained by polishing, diamond turning, or a combination of polishing and diamond turning. Polishing of graphite can be accomplished by spindle polishing using diamond grit (0.5 μm−2.0 μm) mixed in water as an abrasive (polishing force ˜2 psi, spindle speed ˜25 rpm) and Gugolz lapping pitch (#64) for fine polishing (polishing force ˜0.5 psi, spindle speed ˜10 rpm).

Diamond turning conditions suitable for finishing graphite surfaces include turning with a 2 mm radius diamond tool at a speed of 1000 rpm and a feed rate of 5 mm/min.

The finish (rms roughness) of a surface of the graphite substrate may be less than 500 Å, or less than 300 Å, or less than 200 Å, or less than 100 Å, or in the range from 50 Å to 500 Å, or in the range from 50 Å to 300 Å, or in the range from 50 Å to 200 Å, or in the range from 50 Å to 150 Å, or in the range from 50 Å to 100 Å, or in the range from 100 Å to 500 Å, or in the range from 100 Å to 300 Å. The peak-to-valley (PV) roughness of a surface of the graphite substrate may be less than 1500 nm, or less than 1250 nm, or less than 1000 nm, or less than 750 nm, or less than 500 nm.

A finishing layer may be formed on the surface of the graphite substrate, preferably a finished surface of the graphite substrate. The finishing layer may be in direct or indirect contact with the graphite substrate. An adhesion layer may be positioned between the finishing layer and the graphite substrate. The graphite substrate may have a finished or unfinished surface. The finishing layer may cover depressions or irregularities present on the surface of the graphite substrate and is composed of a material that can be processed to low surface finish. A reflective layer, reflective stack, or galvanic-compatibility layer may be formed on, and in direct or indirect contact with, the finishing layer. Representative finishing layers include metals, oxides, DLC (diamond-like carbon), B, Ge, and Si. Metals include Ni, Cu, W, Ti, Zr, Hf, Nb, Ta, Mo, and Au. Oxides include Al₂O₃ and SiO₂. Zr, Hf, Nb, Ta, Mo, Al₂O₃, and SiO₂ have coefficients of thermal expansion that are similar to the coefficient of thermal expansion of graphite and may be advantageous when the intended application of the optical element includes exposure to temperatures that vary over a wide range. The finishing layer may also be a reflective layer.

The finishing layer may be formed by electroless plating, physical vapor deposition (PVD), sputtering, evaporation, plasma ion assisted deposition, or a chemical vapor deposition (CVD) process. One method of electroless plating is the MacDermid process. An exemplary low pressure magnetron sputtering process is described in U.S. Pat. No. 5,525,199, the disclosure of which is incorporated by reference herein.

The surface of the finishing layer may be polished or diamond turned to provide a low finish. Polishing of the substrate or performance-enhancing coating may include applying a polishing formulation that includes a colloidal silica medium or a suspension of alumina or other abrasive metal oxide particle. Diamond turning of the finishing layer includes turning with a diamond tool with an appropriate radius at an appropriate speed and feed rate. Specific conditions depend on the material used for the finishing layer and can be determined without undue experimentation by those of skill in the art. As an example, a high phosphorous (10%-12% phosphorous) nickel finishing layer can be diamond turned using a 1.5 mm radius diamond, a speed of 1000 rpm, and a feed rate of 5 mm/min-7 mm/min.

The finishing layer may have a thickness of at least 10 μm, or at least 25 μm, or at least 50 μm, or at least 100 μm, or at least 125 μm, or at least 150 μm, or in the range from 10 μm to 400 μm, or in the range from 25 μm to 300 μm, or in the range from 50 μm to 250 μm. The thickness of the finishing layer is preferably sufficient to cover or fill any voids, gaps or depressions in the surface of the graphite. The surface of the finishing layer may have an rms roughness less than 50 Å, or less than 40 Å, or less than 30 Å, or less than 20 Å, or less than 15 Å, or less than 10 Å. The peak-to-valley (PV) roughness of the finished surface of the finishing layer may be less than 1000 nm, or less than 500 nm, or less than 250 nm, or less than 100 nm, or in the range from 25 nm-1000 nm, or in the range from 50 nm-500 nm, or in the range from 100 nm-300 nm.

The adhesion layer is designed to promote adhesion between the graphite substrate and the overlying layer in closest proximity to the substrate. The overlying layer in closest proximity to the substrate may be a finishing layer, a galvanic-compatibility layer, a reflective layer or a layer in a reflective stack. The adhesion layer is selected to bond with or strongly adhere to graphite. In one embodiment, the adhesion layer includes a carbide-forming element and application of the adhesion layer to the graphite substrate leads to formation of a carbide layer. Representative adhesion layers include Si, W, Ti, B, SiC, and B₄C. Si, for example, provides strong adhesion to graphite through formation of a silicon carbide (SiC) interfacial layer with graphite. The interfacial silicon carbide layer is in direct contact with graphite and has a limited thickness. Further deposition of Si leads to formation of a pure Si layer in direct contact with the SiC interfacial layer to provide a sequence graphite/SiC/Si. Depending on the amount of Si deposited, an overlying layer may be formed in direct contact with SiC or Si. The overlying layer may be a finishing layer, reflective layer, or layer in a reflective stack.

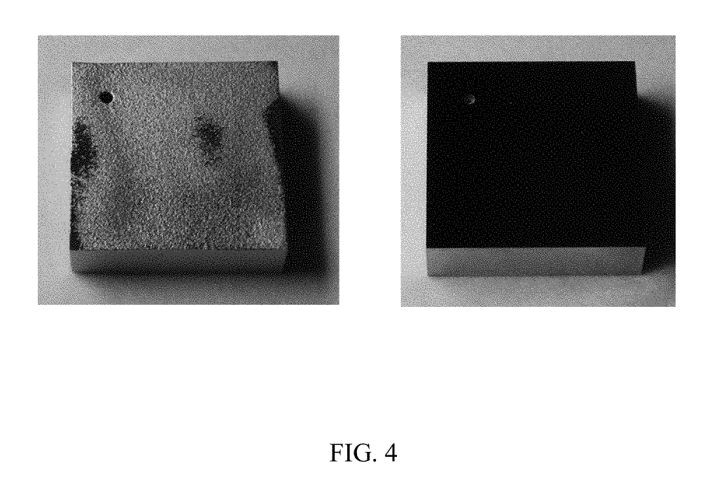

FIG. 4 shows an optical element having a Si adhesion layer in direct contact with a dense graphite substrate and a Ni finishing layer in direct contact with the Si adhesion layer. Various samples of the type shown in FIG. 4 were prepared. The graphite substrate had a grain size of 2 μm, a density of 1.84 g/cm³. The Si adhesion layer was deposited by PVD. Typical thicknesses for the Si adhesion layer were in the range from 0.5 μm-5.0 μm. A sputtered coating of high phosphorous Ni with thickness in the range from 0.5 μm-1.0 μm was formed on the Si adhesion layer and provided an activating surface for electroless Ni plating (MacDermid process) of a Ni finishing layer with a thickness above 100 μm. The surface of the Ni finishing layer was treated by diamond turning (1.5 mm radius diamond, 1000 rpm speed, and feed rate of 5 mm/min-7 mm/min) and polishing to achieve an rms surface roughness of 7 Å. The left side image in FIG. 4 shows the surface of the Ni layer before finishing and the right side image in FIG. 4 shows the surface of the Ni layer after finishing.

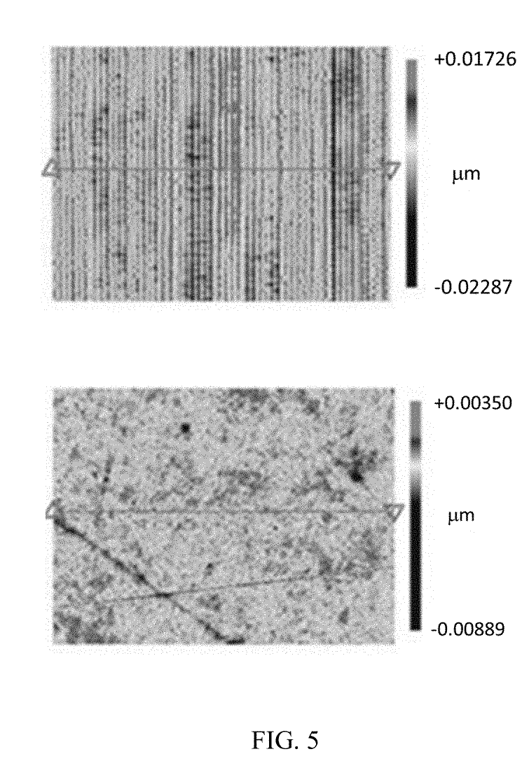

FIG. 5 shows surface finish images from an optical profilometer (Zygo) of the sample shown in FIG. 4 at two stages of treatment of the Ni finishing layer. The upper image shows the surface of the Ni finishing layer after diamond turning and before polishing. The image indicates that the rms roughness of the Ni surface after diamond turning was 48 Å and that the peak-to-valley roughness was 403 Å. The lower image shows the surface of the diamond-turned Ni finishing layer after further polishing. The image indicates that the rms roughness of the diamond-turned Ni surface after polishing was 7 Å and that the peak-to-valley roughness was 123Å.

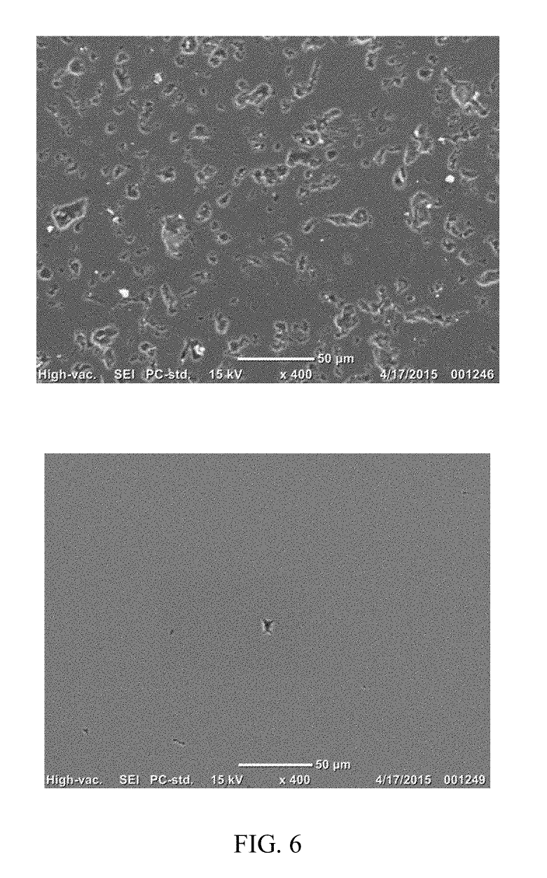

FIG. 6 shows an SEM image of a graphite substrate (POCO Graphite Inc., product no. PLS-2) before and after coating with Si. The upper image of FIG. 6 shows the surface of the graphite substrate after polishing. A layer of Si was then deposited on the polished graphite substrate by PVD. The Si layer had a thickness of 15 μm, which was large enough to allow Si to function both as an adhesion layer at the interface with the graphite substrate and as a finishing layer. The lower image of FIG. 6 shows the surface of the Si layer after polishing. Polishing of the Si layer was accomplished by spindle polishing using zirconium oxide (Eminess Inc., product no. 100Z) mixed in water as an abrasive (polishing force ˜2 psi, spindle speed ˜25 rpm) and Gugolz lapping pitch (#64) for fine polishing (polishing force ˜0.5 psi, spindle speed ˜10 rpm). A significant improvement in the quality of the surface was observed upon application of the Si layer.

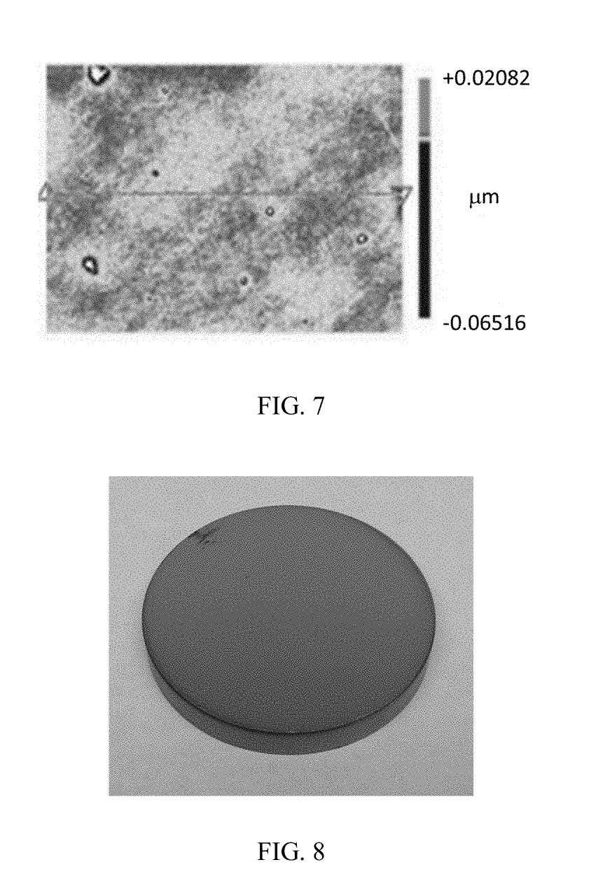

FIG. 7 shows a surface finish image from an optical profilometer (Zygo) of the Si layer for the sample shown in the lower image of FIG. 6. The profilometer image was analyzed and indicated that the rms roughness of the Si layer was 10 Å and the peak-to-valley roughness of the Si layer was 860 Å. FIG. 8 shows a larger scale view of the Si-coated graphite substrate.

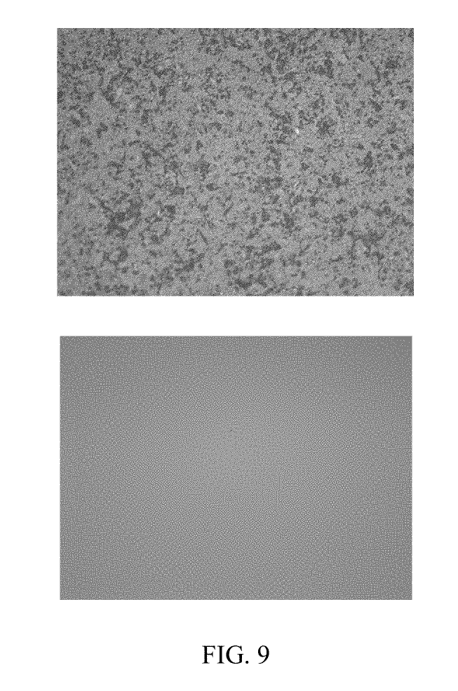

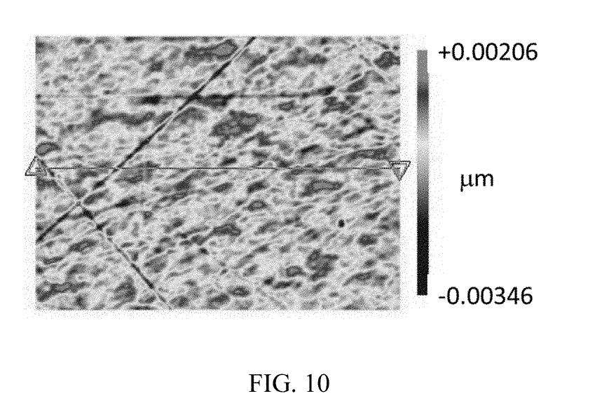

FIG. 9 shows Nomarski microscope images (400×) of a graphite substrate before and after coating with Si. The graphite substrate had a grain size of 2 μm and was polished by spindle polishing using diamond grit (0.5 μm-2.0 μm) mixed in water as an abrasive (polishing force ˜2 psi, spindle speed ˜25 rpm) and Gugolz lapping pitch (#64) for fine polishing (polishing force ˜0.5 psi, spindle speed ˜10 rpm). The upper image of FIG. 9 shows the surface of the graphite substrate after polishing. A layer of Si was then deposited on the polished graphite substrate by PVD. The Si layer had a thickness of 125 μm, which was large enough to allow Si to function as an adhesion layer at the interface with the graphite substrate and as a finishing layer. The lower image of FIG. 9 shows the surface of the Si layer after finishing by spindle polishing using zirconium oxide (Eminess Inc., product no. 100Z) mixed in water as an abrasive (polishing force ˜2 psi, spindle speed ˜25 rpm) and Gugolz lapping pitch (#64) for fine polishing (polishing force ˜0.5 psi, spindle speed ˜10 rpm). A significant improvement in the quality of the surface was observed when using a Si finishing layer. FIG. 10 shows an image obtained from an optical surface profiler of the surface of the Si layer for the sample shown in the lower image of FIG. 9. Data from an image taken from an optical profilometer showed that the rms roughness of the Si layer was 6 Å and that the peak-to-valley roughness of the Si layer was 55Å.

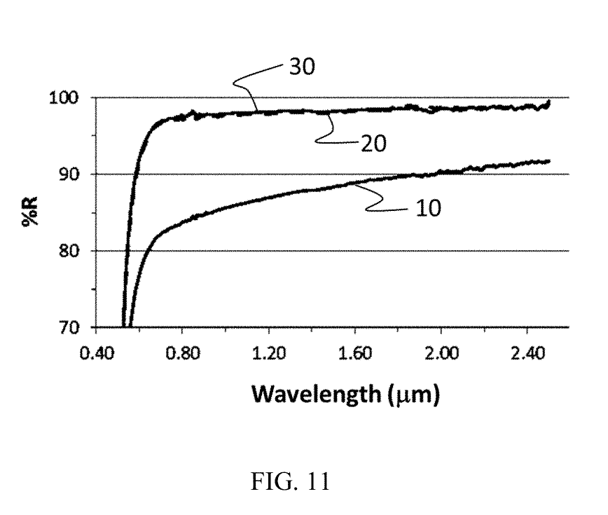

FIG. 11 shows the reflectance of a gold coating (at 12 degrees, formed by PVD thermal resistive deposition) as a function of wavelength for three optical elements. Trace 10 (solid line) shows the reflectance for a gold surface coating having a thickness of 120 nm. The reflective gold coating was formed on top of a Cr layer (10 nm thick), which was formed on top of a Si adhesion layer (60 nm thick), which was formed on top of a graphite substrate (POCO Graphite Inc., product no. PLS-2). The graphite substrate had a grain size of 10 μm, an rms roughness of 1010 Å, and a peak-to-valley roughness of 28400 Å. Trace 20 (dashed line) shows the reflectance for a gold coating having a thickness of 120 nm. The reflective gold coating was formed on top of a Cr layer (10 nm thick), which was formed on top of a Si finishing layer, which was formed on top of a graphite substrate (POCO Graphite Inc., product no. PLS-2). The Si finishing layer was deposited by PVD, had a thickness of approximately 15 μm and was polished. The graphite substrate had a grain size of 10 μm, an rms roughness of 10 Å, and a peak-to-valley roughness of 860 Å. Trace 30 (solid line) shows a reference optical element in which the gold coating was formed directly on a smooth glass substrate. The results indicate that a significant improvement in reflectance occurs when a Si finishing layer is included in the thin film stack of the optical element. The reflectivity achieved with the polished Si finishing layer was virtually identical to the reference Au-coated glass.

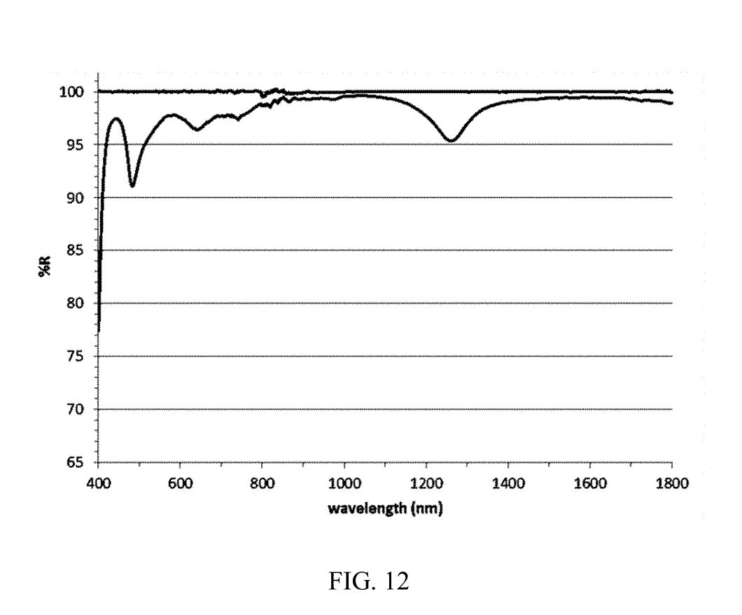

FIG. 12 shows the reflectance of Ag on a Ni-plated graphite substrate. The reflectance was measured at an angle of incidence of 12 °. The graphite substrate (MWI Inc., product no. EC-17) had a grain size of 2 μm. The Ni finishing layer was in direct contact with an adhesion layer, which was in direct contact with the graphite substrate. The Ni finishing layer was formed by electroless plating (MacDermid process) directly on the adhesion layer. The Ni finishing layer had a thickness of 150 μm and was polished to a final finish. The reflective Ag layer was deposited directly on the Ni finishing layer and was finished. The result shown in FIG. 12 indicates high reflectance from the Ag layer over a wide wavelength range in an optical element based on a graphite substrate.

A galvanic-compatibility layer may optionally be included to improve corrosion resistance and chemical stability of the optical element. When deployed in humid or salty operating environments, the relative corrosion resistance of the substrate material and the materials used in the coatings and layers of the optical element is an important consideration. For purposes of electrochemical activity, the materials included in the optical element can be characterized by an anodic index. As is known in the art, corrosion between consecutive layers in a stack of layers becomes problematic if the anodic index difference between the consecutive layers exceeds a certain threshold. The threshold depends on the particular conditions of the operating environment, but is typically in the range from 0.10 V to 0.50 V. If the deployment environment of the optical element exposes it to salt (e.g. salt fog), the anodic index difference should not exceed 0.25 V. If salts are absent from the deployment environment, a higher anodic index difference between consecutive layers can be tolerated while still limiting corrosion.

Materials with a difference in anodic index at or below the threshold are said to have galvanic compatibility. Maintaining galvanic compatibility of consecutive layers in a sequence of layers minimizes the effects of corrosion. If the difference in the anodic index of a finishing layer, reflective layer, or layer in a reflective stack and the anodic index of the graphite substrate exceeds the threshold for galvanic compatibility, it is desirable to include a galvanic-compatibility layer between the finishing layer, reflective layer or layer in a reflective stack and the graphite substrate. The galvanic-compatibility layer should have an anodic index intermediate between the anodic indices of the graphite substrate and overlying finishing layer, reflective layer, or layer in a reflective stack. If the difference in anodic index between the graphite substrate and an overlying finishing layer, reflective layer, or layer in a reflective stack is large, a series of two or more galvanic-compatibility layers may be included. Materials for the galvanic-compatibility layer can be selected to provide a stepwise change in anodic index to insure galvanic compatibility of all adjacent layers in the sequence of layers of the optical element.

In one embodiment, a finishing layer, reflective layer, or layer in a reflective stack is in direct contact with the graphite substrate and the difference between the anodic index of the finishing layer, reflective layer, or layer in a reflective stack and the anodic index of the graphite substrate is less than 0.50 V, or less than 0.40 V, or less than 0.30 V, or less than 0.20 V, or less than 0.10 V.

In one embodiment, a galvanic-compatibility layer is in direct contact with the graphite substrate and an overlying finishing layer, reflective layer, or layer in a reflective stack in direct contact with the galvanic-compatibility layer and the difference between the anodic index of the galvanic-compatibility layer and the anodic index of the graphite substrate is less than 0.50 V, or less than 0.40 V, or less than 0.30 V, or less than 0.20 V, or less than 0.10 V. In one embodiment, the galvanic-compatibility layer is in direct contact with the graphite substrate and in direct contact with a finishing layer, reflective layer, or layer in a reflective stack and the difference between the anodic index of the galvanic-compatibility layer and the anodic index of the finishing layer, reflective layer, or layer in a reflective stack is less than 0.50 V, or less than 0.40 V, or less than 0.30 V, or less than 0.20 V, or less than 0.10 V.

Selection of the material for the galvanic-compatibility layer depends on the anodic index of the material used for an overlying finishing layer, reflective layer, or layer in a reflective stack. The anodic indices of many materials have been determined and are known to those of skill in the art. Graphite is cathodic and has an anodic index of ˜0.15 V (comparable to Pt or Au). Suitable materials for galvanic-compatibility layers for graphite include Ta, Ti, Si and Zr.

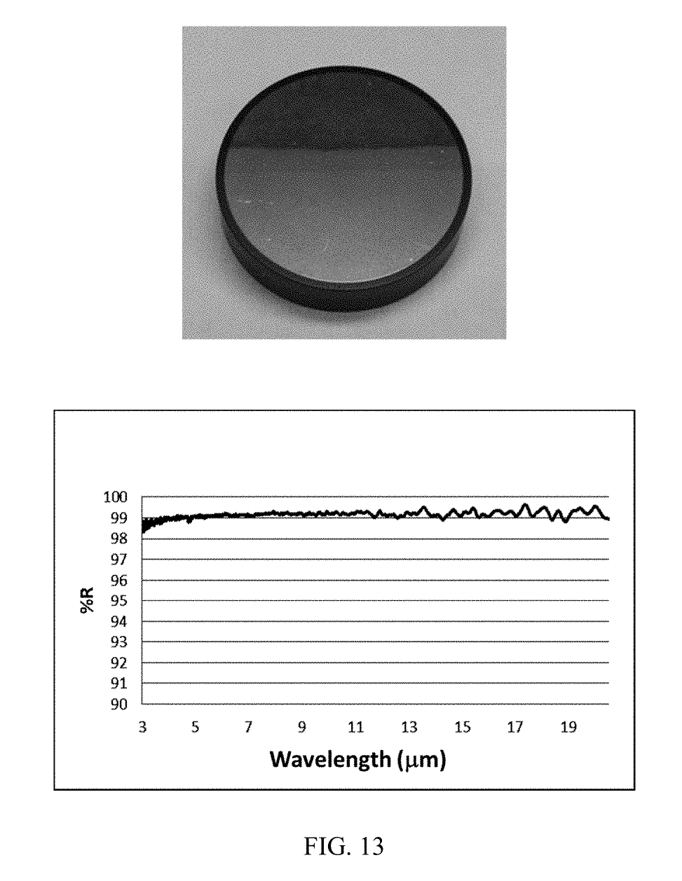

FIG. 13 shows a reflecting optical element with a dense graphite substrate. The optical element included a reflective Au layer in direct contact with a Cr galvanic-compatibility layer in direct contact with a Si adhesion layer in direct contact with a graphite substrate. The graphite substrate had a grain size of 2 μm and a density of 1.84 g/cm³. The Si adhesion layer (Si) was formed on the graphite substrate by PVD. A galvanic-compatibility layer (Cr) was formed on the Si adhesion. A reflective Au layer was formed on the Cr galvanic-compatibility layer. The upper image of FIG. 13 shows the optical element and the lower image of FIG. 13 shows the reflectance of the optical element as a function of wavelength for an angle of incidence of 12 °. Reflectance of 99% over a wide range of wavelengths was observed. The reflecting optic passed the following environment tests defined by the specification MIL-PRF-13830: adherence, extended humidity for 120 hours, and 24 hours of salt spray. The test results indicate chemical stability and resistance to corrosion of the optical element under harsh environmental conditions.

The graphite substrate disclosed herein may function as a substrate for an optical element that include a variety of reflective layers or reflective stacks. The reflective coating preferably provides high reflectivity in one or more of the visible (VIS), near infrared (NIR), shortwave infrared (SWIR), midwave infrared (MWIR), and long wave infrared (LWIR) bands. The reflective coating may be a layer of a single material or a multilayer stack of two or more materials. In one embodiment, the reflective coating includes a reflective layer and one or more tuning layers. The reflective coating may optionally include a barrier layer, one or more interface layers, and one or more protective layers. When present, the one or more protective layers overlie the other layers in the stack.

The reflective layer may include a metal layer or a transition metal layer. The reflective layer preferably has high reflectivity at wavelengths in the VIS, NIR, SWIR, MWIR, and LWIR spectral bands. The reflective metal may be metallic, non-ionic, a pure metal or metal alloy, and/or zero valent. The reflective layer may include one or more elements selected from the group consisting of Ag, Au, Al, Rh, Cu, Pt and Ni. The thickness of the reflective transition metal layer may be in the range from 75 nm to 350 nm, or in the range from 80 nm to 150 nm, or in the range from 90 nm to 120 nm.

The reflective coating may include one or more tuning layers. The one or more tuning layers are positioned between the protective layer(s) of the reflective coating and the finishing layer. In one embodiment, the tuning layer(s) are positioned between the reflective layer and the protective layer(s) of the reflective coating. Tuning layer(s) are designed to optimize reflection in defined wavelength regions. Tuning layer(s) typically include an alternating combination of high and low refractive index materials, or high, intermediate, and low refractive index materials. Materials used for tuning layers are preferably low absorbing in the wavelength range of from 0.4 μm to 15.0 μm. Representative materials for tuning layers include YbF₃, GdF₃, YF₃, YbOₓF_{y}, GdF₃, Nb₂O₅, Bi₂O₃, HfO₂, and ZnS. The tuning layer(s) may have a thickness in the range of 75 nm to 300 nm. In one embodiment, the reflective coating includes YbF₃ and ZnS as tuning layers. The reflective layer and tuning layer(s) may be in direct contact or one or more interface layers may be present between the reflective layer and tuning layer(s). The interface layer(s) may promote adhesion or provide galvanic compatibility between the reflective layer and tuning layer(s). The interface layer(s) needs to have a thickness sufficient for adhesion, but must also be thin enough to minimize absorption of light reflected from the reflective layer. The interface layer(s) positioned between the reflective layer and the tuning layer(s) may have a thickness in the range of 5 nm to 200 nm, or 5 nm to 150 nm, 5 nm to 100 nm, or 10 nm to 100 nm, or 10 nm to 50 nm. The interface layer(s) positioned between the reflective layer and the tuning layer(s) may include one or more of ZnS, Nb₂O₅, TiO₂, Ta₂O₅, Bi₂O₃, Al₂O₃, and reduced forms thereof (e.g. TiO₂₋ₓ, Ta₂O₅₋ₓ, Bi₂O₃₋ₓ, Al₂O₃₋ₓ).

In one embodiment, the reflective layer is in direct contact with the finishing layer. In another embodiment, the optical element includes a barrier layer and/or an interface layer between the reflective layer and the finishing layer. In still another embodiment, the optical element includes a barrier layer in direct contact with the finishing layer. In yet another embodiment, the optical element includes a barrier layer in direct contact with the finishing layer and an interface layer in direct contact with the barrier layer. The interface layer may promote adhesion between the reflective layer and barrier layer, or between the reflective layer and the galvanic-compatibility layer. The interface layer may also insure galvanic compatibility of the reflective coating with the finishing layer, or galvanic compatibility of the barrier layer with the reflective layer. The barrier layer may insure galvanic compatibility between the reflective layer and the graphite substrate. The barrier layer may also function as a finishing layer consistent with the principles disclosed herein.

Representative barrier layers include Si₃N₄, SiO₂, TiAlN, TiAlSiN, TiO₂, DLC (diamond-like carbon), Al, CrN, and SiₓN_{y}O_{z}. The barrier layer may have a thickness in the range from 100 nm to 50 μm, or in the range from 500 nm to 10 μm, or in the range from 1 μm to 5 μm. One criterion for determining the thickness of the barrier is the number of hours the article will have to withstand the salt fog test. The longer the duration of the salt fog test, the greater the required thickness of the barrier layer. For a salt fog test of 24 hours, a barrier layer of 10 μm may be sufficient. The thickness of the barrier layer can also be adjusted to accommodate changes in temperature without distorting the figure of the optical element. Thermal stresses increase as the operational temperature range increases, so thinner barrier layers are recommended to avoid figure distortion in deployment environments experiencing large swings in temperature.

Representative interface layers positioned between the finishing layer and the reflective layer include one or more of Ni, Cr, Ni—Cr alloys (e.g. Nichrome), Ni—Cu alloys (e.g. Monel), Ti, TiO₂, ZnS, Pt, Ta₂O₅, Nb₂O₅, Al₂O₃, AlN, AlOₓN_{y}, Bi, Bi₂O₃, Si₃N₄, SiO₂, SiOₓN_{y}, DLC (diamond-like carbon), MgF₂, YbF₃, and YF₃. The interface layer may have a thickness in the range from 0.2 nm to 25 nm, where the lower end of the thickness range (e.g. 0.2 nm to 2.5 nm, or 0.2 nm to 5 nm) is appropriate when the interface layer is a metal (to prevent parasitic absorbance of light passing through the reflective coating) and the higher end of the thickness range (e.g. 2.5 nm to 25 nm, or 5 nm to 25 nm) is appropriate when the interface layer is a dielectric. When the reflectivity of the reflective layer is sufficiently high such that negligible light is transmitted through the reflective layer, no particular upper limit applies to the thickness of the interface layer.

The protective layer provides resistance to scratches, resistance to mechanical damage, and chemical durability. Representative materials for the protective layer include YbF₃, YbFₓO_{y}, YF₃ and Si₃N₄. The protective layer(s) is the top layer of the reflective coating. The protective layer(s) may have a thickness in the range of 60 nm to 200 nm.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the illustrated embodiments. Since modifications, combinations, sub-combinations and variations of the disclosed embodiments that incorporate the spirit and substance of the illustrated embodiments may occur to persons skilled in the art, the description should be construed to include everything within the scope of the appended claims and their equivalents.

what is claimed is:

1. An optical element comprising:
a graphite substrate; and
a finishing layer in direct or indirect contact with said graphite substrate, said finishing layer comprising an rms surface roughness less than 50Å.

2. The optical element of claim 1, wherein said graphite substrate comprises a grain size of less than 10.0Å.

3. The optical element of claim 1, wherein said graphite substrate comprises a surface with an rms roughness in the range from 50 Å to 150Å.

4. The optical element of claim 1, wherein said graphite substrate comprises a surface with a peak-to-valley roughness less than 1000 nm.

5. The optical element of claim 1, wherein said graphite substrate includes a diamond-turned surface.

6. The optical element of claim 1, wherein said finishing layer comprises a surface with an rms roughness less than 20Å.

7. The optical element of claim 1, wherein said finishing layer comprises a surface with a peak-to-valley roughness less than 50Å.

8. The optical element of claim 1, wherein said finishing layer comprises a thickness in the range from 30 μm to 400 μm.

9. The optical element of claim 1, wherein said finishing layer includes a diamond-turned surface.

10. The optical element of claim 1, wherein said finishing layer comprises Ni or Si.

11. The optical element of claim 1, wherein said finishing layer is in direct contact with said graphite substrate.

12. The optical element of claim 1, further comprising:
a carbide layer between said graphite substrate and said finishing layer.

13. The optical element of claim 12, wherein said carbide layer comprises Si.

14. The optical element of claim 1, further comprising:
an adhesion layer between said graphite substrate and said finishing layer, said adhesion layer comprising a carbide-forming element.

15. The optical element of claim 1, further comprising:
a reflective layer on said finishing layer.

16. The optical element of claim 15, wherein said reflective layer includes a diamond-turned surface.

17. An optical element comprising:
a graphite substrate, said graphite substrate comprising a diamond-turned surface.

18. A method for forming an optical element comprising:
diamond turning a surface of a graphite substrate.

19. The method of claim 18, further comprising forming a reflective layer in direct or indirect contact with said diamond-turned surface of said graphite substrate.

20. The method of claim 19, further comprising forming a finishing layer in direct or indirect contact with said diamond-turned surface of said graphite substrate, said finishing layer being formed between said diamond-turned surface of said graphite substrate and said reflective layer.
